(19) United States
(12) Patent Application Publication
(10) Pub. No.: US 2026/0273987 A1
(43) Pub. Date: Sep. 17, 2026

(54) PRECISION WATERMARKING OF COVERT AND OVERT AUTHENTICATION FEATURES

(71) Applicant: Crane & Co., Inc., Dalton, MA (US)

(72) Inventors: Michael Darroch, Dalton, MA (US); Paul Mirto, Pittsfield, MA (US)

(21) Appl. No.: 19/469,923

(22) PCT Filed: Dec. 29, 2023
(86) PCT No.: PCT/US2023/086542

§ 371 Date: Sep. 26, 2025

Related U.S. Application Data
(60) Provisional application No. 63/492,406, filed on Mar. 27, 2023.

(51) Int. Cl. B42D 25/333

(52) U.S. Cl. CPC B42D 25/333

(57) ABSTRACT

A security document including a substrate and a first indicia occupying a first predetermined region of the substrate, the first indicia having a first pattern comprising a first reference point and a second reference point and a second indicia occupying a second predetermined region of the substrate, the second indicia having a second pattern comprising a third reference point, wherein the first reference point, second reference point, and third reference point fit a first line, wherein a distance between the first line and the first reference point comprises a first perpendicular offset, wherein a distance between the first line and the second reference point comprises a second perpendicular offset, wherein a distance between the first line and the third reference point comprises a third perpendicular offset, and wherein each of the first, second, and third perpendicular offsets are equal to or less than a first threshold value.

### CROSS-REFERENCE TO RELATED APPLICATIONS

This application is a 371 National Stage of International Application No. PCT/US2023/086542, filed Dec. 29, 2023, which claims priority to U.S. Provisional Patent Application No. 63/492,406, filed Mar. 27, 2023, the disclosures of which are incorporated herein by reference.

### TECHNICAL FIELD

The present disclosure relates to enhancing the counterfeit resistance of security documents, such as currency notes, passports, and other documents comprising watermarks and other security features. More specifically, this disclosure relates to security documents with precision watermarking of covert and overt authentication features and methods for producing same.

### BACKGROUND

Hardening passports, banknotes and other documents (referred to herein as “security documents”) whose constructional features include hard-to-reproduce indicia of the documents' authenticity against counterfeiting remains an ongoing source of technical challenges and opportunities for improvement in the field of security document design.

Improvements in printing and scanning technologies, as well as online marketplaces for previously impossible-to-source materials, such as color-changing inks, have provided counterfeiters and malicious actors with the tools to make serviceable reproductions of the printed features of security documents. Additionally, to the extent materials teaching the basic techniques for watermarking are widely available in print and online, malicious actors can, to some extent reproduce certain non-printed security features of security documents, such as watermarks.

While central banks and other legitimate actors generally retain a monopoly on the design and production of micro-optic security strips and other indicia of authenticity which are difficult or impossible for malicious actors to reproduce, improving traditional, or “Level 1” (referring to security features which can be detected by the naked eye) security features in ways that malicious actors cannot detect and/or reproduce remains a source of technical challenges and opportunities for improvement in the art.

### SUMMARY

The present disclosure illustrates embodiments of a security document security documents with precision watermarking of covert and overt authentication features and methods for producing same.

In a first embodiment a security document includes a substrate; a first indicia occupying a first predetermined region of the substrate, the first indicia having a first pattern comprising first and second reference points; and a second indicia occupying a second predetermined region of the substrate, the second indicia having a second pattern comprising a third reference point, wherein the first reference point, second reference point and third reference point fit a first line, wherein a distance between the first line and the first reference point comprises a first perpendicular offset, wherein a distance between the first line and the second reference point comprises a second perpendicular offset, wherein a distance between the first line and the third reference point comprises a third perpendicular offset, and wherein each of the first, second and third perpendicular offsets are equal to, or less than a first threshold value.

In a second embodiment, a method of making a security document includes forming, in or on a substrate, a first indicia occupying a first predetermined region of the substrate, the first indicia having a first pattern comprising first and second reference points; and forming, in or on the substrate, a second indicia occupying a second predetermined region of the substrate, the second indicia having a second pattern comprising a third reference point, wherein the first reference point, second reference point and third reference point fit a first line, wherein a distance between the first line and the first reference point comprises a first perpendicular offset, wherein a distance between the first line and the second reference point comprises a second perpendicular offset, wherein a distance between the first line and the third reference point comprises a third perpendicular offset, and wherein each of the first, second and third perpendicular offsets are equal to, or less than a first threshold value.

In a third embodiment, a secure document includes a substrate having a predetermined width and a predetermined length; a first covert feature formed in the substrate; and a second covert feature formed in the substrate; wherein the first covert feature is disposed at a first location on the substrate, the first location corresponding to a first registration region of an authenticating overlay, and wherein the second covert feature is disposed at a first location on the substrate, the first location corresponding to a second registration region of the authenticating overlay.

In a fourth embodiment, a method of creating a secure document includes, on a substrate having a predetermined width and a predetermined length, forming a first covert feature in or on the substrate; and forming a second covert feature in or on the substrate; wherein the first covert feature is disposed at a first location on the substrate, the first location corresponding to a first registration region of an authenticating overlay, and wherein the second covert feature is disposed at a first location on the substrate, the first location corresponding to a second registration region of the authenticating overlay.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of a security document according to certain embodiments of this disclosure;

FIG. 2 illustrates an example of a security feature according to certain embodiments of this disclosure;

FIG. 3 illustrates an example of encoding indicia of authenticity through registration patterns of overt features according to certain embodiments of this disclosure;

FIGS. 4A and 4B illustrate further examples of encoding indicia of authenticity through registration patterns of overt features according to various embodiments of this disclosure;

FIGS. 5A and 5B illustrate examples of encoding indicia of authenticity through registration patterns of covert features, according to various embodiments of this disclosure; and

FIGS. 6A and 6B illustrate examples of an authentication overlay for assessing indicia of authenticity encoded as registration patterns of security features according to various embodiments of this disclosure.

### DETAILED DESCRIPTION

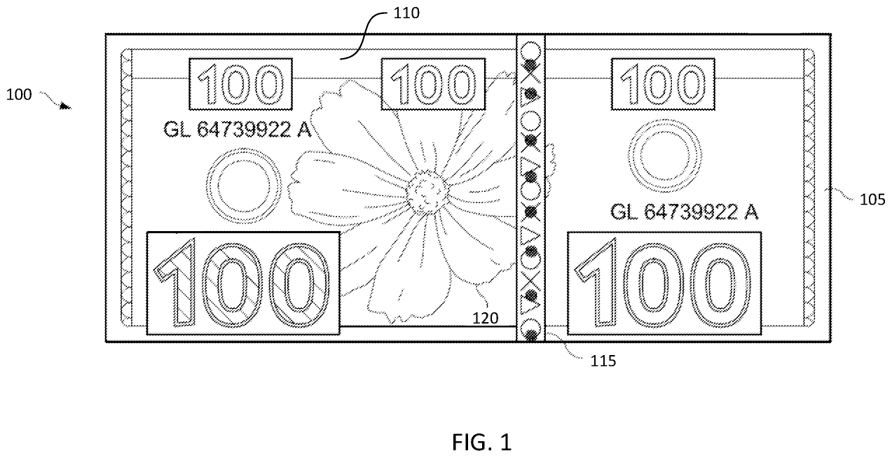

FIGS. 1 through 6B, discussed below, and the various embodiments used to describe the principles of the present disclosure are by way of illustration only and should not be construed in any way to limit the scope of the disclosure. Those skilled in the art will understand that the principles of the present disclosure may be implemented in any suitably arranged security document.

Although the present disclosure has been described with various embodiments, various changes and modifications may be suggested to one skilled in the art. It is intended that the present disclosure encompass such changes and modifications as falling within the scope of the claims.

The present disclosure should not be read as implying that any particular element, step, or function is an essential element, step, or function that must be included in the scope of the claims. Moreover, the claims are not intended to invoke 35 U.S.C. § 112(f) unless the exact words “means for” are followed by a participle.

FIG. 1 illustrates an example of a security document according to certain embodiments of this disclosure.

While the proliferation of imaging tools, raw materials, and some of the basic know-how associated with the production of security documents has enabled counterfeiters and other malicious actors to make increasingly better facsimiles of the printed and watermarked features of security documents, legitimate actors, such as central banks and producers of currency paper and currency supplies for central banks retain an upper hand in terms of process control, and the precision with which they can register printed and watermarked features on the document surface and relative to each other.

As discussed in greater detail herein, certain embodiments according to this disclosure leverage the superior process control and registration accessible to legitimate actors to encode and encrypt (i.e., selectively obfuscate the criteria for authenticity) additional indicia of authenticity using traditional printed and watermarked features. In this way, certain embodiments according to the present application provide the practical and technical benefits of extending the utility of printed and watermarked features as reliable indicia of authenticity, without requiring significant retooling by legitimate actors.

Referring to the non-limiting example of FIG. 1, an example of a security document 100 according to various embodiments of this disclosure is shown. In this illustrative example, security document 100 is a currency note, though other embodiments (for example, tickets, identification papers, etc.) are within the contemplated scope of this disclosure. According to some embodiments, security document 100 comprises a fibrous substrate 105, which is formed from a wet web of fibrous material (for example, wood pulp, cotton fiber, linen fiber, flax fiber, sisal fiber, hemp fiber, Abaca fiber, Kozo fiber, Mitsumata fiber, bamboo fiber, Kenaf fiber, and/or synthetic fiber), which is laid down (for example, in a Fourdrinier process) at a first, baseline fiber density. Regions of the web in which the first fiber density is not altered while the web is wet (for example, through the use of wire rolls, electrotypes or other watermarking tools) prior to pressing, drying, and, in some embodiments, calendaring, form bulk regions 110 of security document 100. As used in this disclosure, the expression “bulk region” encompasses a portion of a fibrous substrate embodying one or more of a baseline fiber density, baseline light absorption, or baseline caliper thickness. Put differently, as used in this disclosure, the expression “bulk region” encompasses portions of a finished fibrous substrate in which the locations of the constituent fibers are not deliberately altered (for example, through the use of embossed wirecloth or electrotypes) as part of the papermaking process.

As shown in the explanatory example of FIG. 1, security document 100 further comprises one or more security features 115 adhered to the surface of security document 100. Security feature 115 comprises a thin section of material with one or more optical structures, such as structures comprising an embossed or cast-cured outer surface that provides an optically variable effect. Examples of optical structures provided on security feature 115 include, without limitation, micro-lenses, diffractive structures, and micro-optic icons. Examples of optically variable effects provided by the optical structures of security feature 115 include, without limitation, holograms, color shift effects, and synthetic images, characterized by the synthetic projection of portions of image icons across an array of image icons by focusing elements of an array of focusing elements, wherein the scale ratio (i.e., the ratio of the repeat period of the focusing elements to the repeat period of the image icons) is approximately 1.000.

Security document 100 further comprises one or more watermarks 120. According to various embodiments, watermarks 120 comprise one or more regions in which the fiber density of fibrous substrate 105 is deliberately altered (either increased or decreased) from the fiber density in bulk region 110 to form a visible pattern of light (i.e., allowing more light to pass in transmission through the fibrous substrate than bulk region 110) and/or dark (i.e., less light to pass in transmission through the fibrous substrate than bulk region 110) elements. One or more watermarks 120 may, in some embodiments, be formed using a dandy roll or other wire cloth embossing screen. In some embodiments, one or more watermarks 120 may be formed using an electrotype. In some embodiments, at least a portion of watermark 120 is covered by part of security feature 115, wherein security feature 115 is maintained in contact with functional watermark 120 by an adhesive bond.

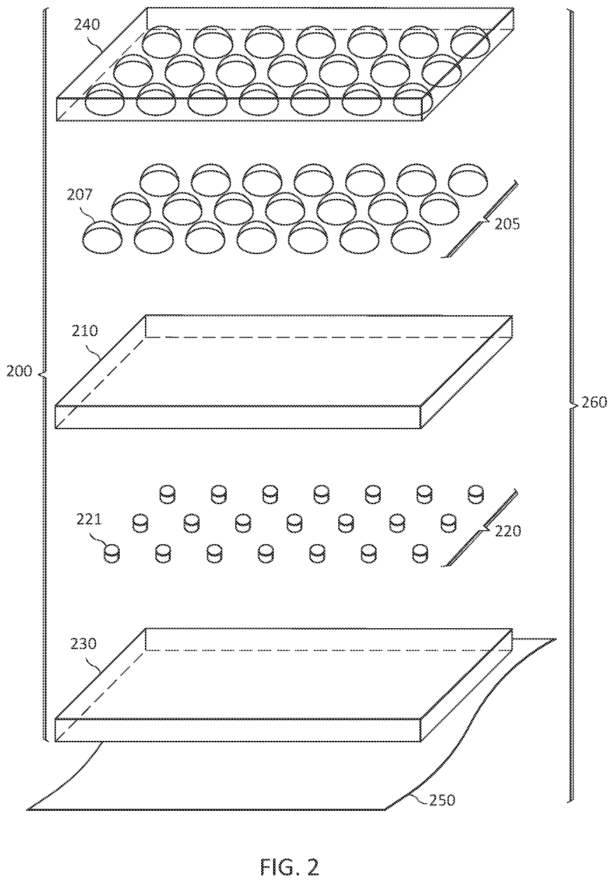

FIG. 2 illustrates constructional aspects of a micro-optic security device (for example, security feature 115 in FIG. 1) comprising part of a security document according to various embodiments of this disclosure.

Referring to the non-limiting example of FIG. 2, optical security device 200 comprises a plurality of focusing elements 205 (including, for example, focusing element 207) and an arrangement of image icons 220 (including, for example, image icon 221). According to various embodiments, each focusing element of plurality of focusing elements 205 has a footprint, in which one or more image icons of arrangement of image icons 220 is positioned. Collectively, the focusing elements of plurality of focusing elements 205, magnify portions of image icons 220 to produce a synthetic magnification effect (also referred to as “synthetic image”) wherein the individually microscopic image icons are collectively magnified by the plurality of focusing elements 205 to produce an image which dynamically reacts (for example, by appearing to move, or change colors) in response to shifts in viewing angle. Given the small scale and tight manufacturing tolerances of the constituent structures of optical security device providing the moiré magnification effect, many malicious actors are not able to produce counterfeit versions of optical security device 200. Accordingly, optical security device 200 is, in many cases, a trusted visual indicium of a security document's (for example, security document 260) authenticity.

According to certain embodiments, plurality of focusing elements 205 comprises a planar array of micro-optic focusing elements. In some embodiments, the focusing elements of plurality of focusing elements 205 comprise micro-optic refractive focusing elements (for example, plano-convex or GRIN lenses). Refractive focusing elements of plurality of focusing elements 205 are, in some embodiments, produced from light cured resins with indices of refraction ranging from 1.35 to 1.7 and have diameters ranging from 5 μm to 200 μm. In various embodiments, the focusing elements of plurality of focusing elements 205 comprise reflective focusing elements (for example, very small concave mirrors), with diameters ranging from 5 μm to 50 μm. While in this illustrative example, the focusing elements of plurality of focusing elements 205 are shown as comprising circular plano-convex lenses, other refractive lens geometries, for example, lenticular lenses, are possible and within the contemplated scope of this disclosure.

As shown in the illustrative example of FIG. 2, arrangement of image icons 220 comprises a set of image icons (including image icon 221), positioned at predetermined locations within the footprints of the focusing elements of plurality of focusing elements 205. According to various embodiments, the individual image icons of arrangement of image icons 220 comprise regions of light cured material associated with the focal path of structured light (for example, collimated UV light) passing through plurality of focusing elements 205 from a projection point associated with one or more predetermined ranges of viewing angles. In some embodiments, the individual image icons of arrangement of image icons 220 are not provided within a structured image icon layer. As used in this disclosure, the term “structured image layer” encompasses a layer of material (for example, a light-curable resin) which has been embossed or otherwise formed to comprise structures (for example, recesses, posts, grooves, or mesas) for positioning and retaining image icon material. According to various embodiments, the individual image icons of arrangement of image icons 220 are provided within a structured image layer, the structured image layer comprising one or more of voids, mesas, or posts, which act as retaining structures to hold micro and nano-scale volumes of colored material.

As shown in the illustrative example of FIG. 2, in certain embodiments, optical security device 200 includes an optical spacer 210. According to various embodiments, optical spacer 210 comprises a film of substantially transparent material (for example, polyethylene terephthalate (“PET”) or Biaxially-Oriented Polypropylene (“BOPP”)) which operates to position image icons of arrangement of image icons 220 in or around the focal plane of focusing elements of plurality of focusing elements 205. In certain embodiments according to this disclosure, optical spacer 210 comprises a manufacturing substrate upon which one or more layers of light curable material can be applied, to form one or more of arrangement of image icons 220 or plurality of focusing elements 205.

According to various embodiments, optical security device 200 comprises one or more regions of light-cured protective material which occupy the spaces between the image icons of arrangement of image icons 220. In some embodiments, the arrangement of image icons 220 is formed first (for example, by selectively curing and removing liquid light-curable material on optical spacer 210), then a layer of clear, light-curable material is applied to fill spaces between the image icons of arrangement of image icons 220, and then flood-cured to create a protective layer, which protects the image icons from being moved from their positions within the footprints of focusing elements of plurality of focusing elements 205. In certain embodiments, the light-curable material used to form arrangement of image icons 220 is a pigmented, ultraviolet (UV)-curable polymer.

In some embodiments, arrangement of image icons 220 is affixed to a second substrate 230, which operates to protect and secure arrangement of image icons 220 and provide an interface for attaching optical security device 200 to a substrate 250 as part of security document 260. In some embodiments, optical security device 200 is affixed to substrate 250 during the manufacture of substrate in a paper-making machine, such as a Fourdrinier machine. According to some embodiments, optical security device 200 is affixed to substrate 250 by a layer of adhesive between the arrangement of image icons and a top surface of substrate 250.

In certain embodiments according to this disclosure, optical security device 200 comprises a seal layer 240. According to certain embodiments, seal layer 240 comprises a thin layer (for example, a layer 2 μm to 50 μm thick) of substantially clear material which interfaces on a lower surface, with focusing elements of the plurality of focusing elements 205 and comprises an upper surface with less variation in curvature (for example, by being smooth, or by having a surface whose local undulations are of a larger radius of curvature than the focusing elements) than the plurality of focusing elements 205.

While FIG. 2 provides one example of an optical security device according to various embodiments, the present disclosure is not so limited. Other optical security devices which are susceptible to being damaged from being tugged upon or otherwise subjected to abruptly increasing force and include hard-to-reproduce micro and nano-scale optical structures (for example, holograms, devices providing thin-film effects, devices producing diffraction-based optical effects) which provide harvesting targets for malicious actors are within the contemplated scope of this disclosure.

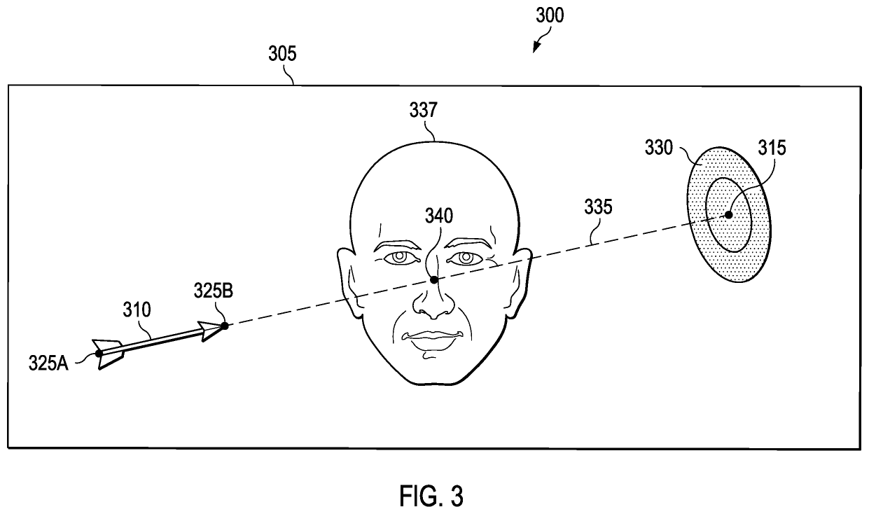

FIG. 3 illustrates one example of a security document with overt features providing encoded indicia of authenticity according to various embodiments of this disclosure.

Referring to the non-limiting example of FIG. 3, a security document 300 comprises a fibrous substrate 305 (for example, fibrous substrate 105 in FIG. 1), upon which a first watermark 310 and a second watermark 315 have been formed. As shown in FIG. 3, first watermark 310 occupies a first predetermined region of fibrous substrate 305, wherein the first predetermined region may be defined according to values of a coordinate system having x and y axes and an origin 320 corresponding to the lower left hand corner of fibrous substrate 305. Naturally, other coordinate systems and origin points are within the contemplated scope of this disclosure. Referring again to the illustrative example of FIG. 3, second watermark 315 likewise occupies a second predetermined region of fibrous substrate 305 that can be defined according to values of a coordinate system with an origin point (for example, origin 320) on fibrous substrate 305.

In this example, first watermark 310 comprises both light regions (as used in this disclosure, the expression “light region” encompasses portions of a watermark in which the fiber density has been reduced relative to the bulk portion of the security document, making the light region appear lighter or less opaque than baseline for the fibrous substrate) and dark regions (as used in this disclosure, the expression “dark region” encompasses portions of a watermark in which the fiber density has been increased relative to the bulk portion or baseline fiber density, causing the dark region to appear darker or more opaque than baseline for the fibrous substrate). Similarly, in this example, second watermark 315 also comprises both dark and light regions. However, embodiments in which one or both of first watermark 310 and second watermark 315 only comprise light or dark regions are possible and within the contemplated scope of this disclosure.

Referring to the explanatory example of FIG. 3, the pattern of light and/or dark regions defining first watermark 310 creates one or more reference points (for example, reference points 325A and 325B). As used in this disclosure, the expression “reference point” encompasses a region (for example, measuring 1 mm×1 mm or less) with little surface area, which can be readily identified with the naked eye. Examples of reference points include, without limitation, corners of shapes within a watermark pattern, standalone points, and points of intersection between lines within the watermark pattern. For example, in FIG. 3, first reference point 325A corresponds to a corner of a first triangle-shaped region defining the feathers of an arrow and second reference point 325B corresponds to a corner of a second triangle-shaped region defining the tip of the arrow. Similarly, in this example, second watermark 315 comprises a third reference point 330, which is a standalone dot marking the bullseye region of a target.

As shown in the explanatory example of FIG. 3, additional indicia of the authenticity of security document 300 can be encoded through the placement and registration of reference points 325A, 325B, and 330. In this example, each of reference points 325A, 325B, and 330 are co-linear and comprise points along line 335. Copying the registration of watermarks on a substrate, particularly where two separate watermarking tools (for example, a wire cloth and an electrotype) are required to produce first watermark 310 and second watermark 315, can be extremely challenging and is typically beyond what most malicious actors can achieve without either the masters of the embossing tools for producing watermarks or capital-intensive machinery for precision manufacturing of security documents. Adding to the challenge is that, unlike original manufacturers who design and manufacture security documents according to their own specifications, counterfeiters typically have to reverse-engineer and copy features from a sample document.

To reproduce the precise registration between watermarked features of an original security document, a malicious actor typically needs to have an exact copy of the watermarking tool used to make the original or needs to be able to precisely and repeatedly position two different watermarking tools at exactly the same location. Experience has shown that malicious actors cannot, as a rule, position watermarks on a substrate at the same level of registration accuracy as original manufacturers.

In the example of FIG. 3, the registration accuracy provided by the original manufacturer's access to a master watermarking tool or improved process control is leveraged to encode indicia of authenticity through the alignment of reference points 325A, 325B, and 330, which all sit on line 335. In this way, everyday users (for example, shopkeepers and others who routinely handle cash, but do not necessarily have access to banknote equipment manufacturer (“BEM”) or other “Level 2” authentication equipment) can easily check the authenticity of security document 300 by using a ruler or straightedge to confirm the alignment between alignment points 325A, 325B, and 330.

Still referring to the explanatory example of FIG. 3, the registration precision advantages available to banknote manufacturers and other legitimate actors can be further leveraged to encode additional indicia of authenticity into a security document by aligning reference points in printed features (or features of applied security devices, such as security feature 115 in FIG. 1). For example, printed feature 340 (in this example, an intaglio print of a face) comprises a fourth reference point 345, corresponding to the nose of the face of printed feature 335. As shown in the figure, fourth reference point 345 sits along line 335, thereby presenting a further layer of registration-themed challenge for malicious actors looking to counterfeit security document 300. In addition to ensuring the alignment of watermark-based reference points 325A, 325B, and 330 along line 335, malicious actors looking to produce serviceable counterfeits of security document 300 would also need to align printed reference point 340 to line 335. In this way, certain embodiments according to this disclosure amplify the costs and challenges of reproducing security document 300.

While FIG. 3 has been described with reference to a fibrous substrate, embodiments according to the present disclosure are not so limited and the methods for leveraging superior process control and/or access to master tools to encode registration-based indicia of authenticity described with reference to FIG. 3 can be applied in embodiments using polymeric or other substrates, in which overt features can be formed through printing, laser marking, or embossing.

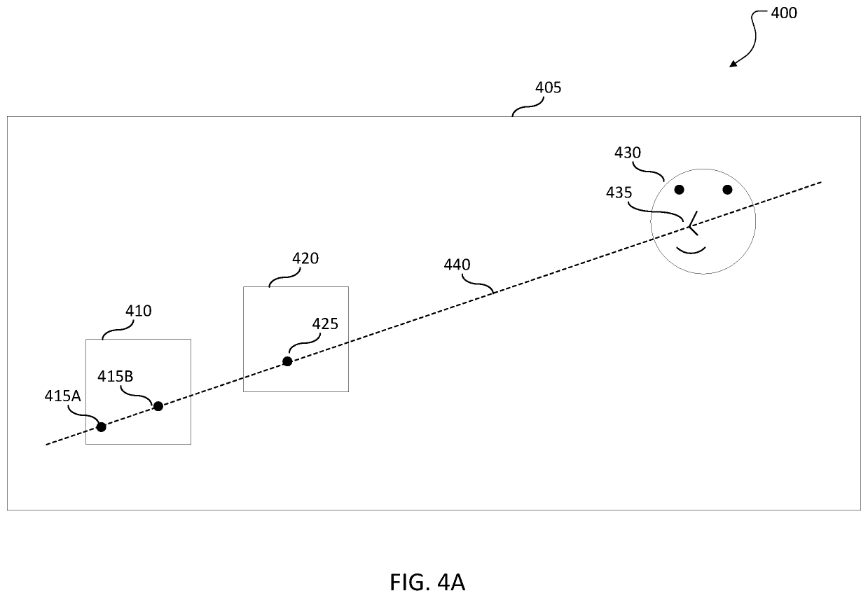

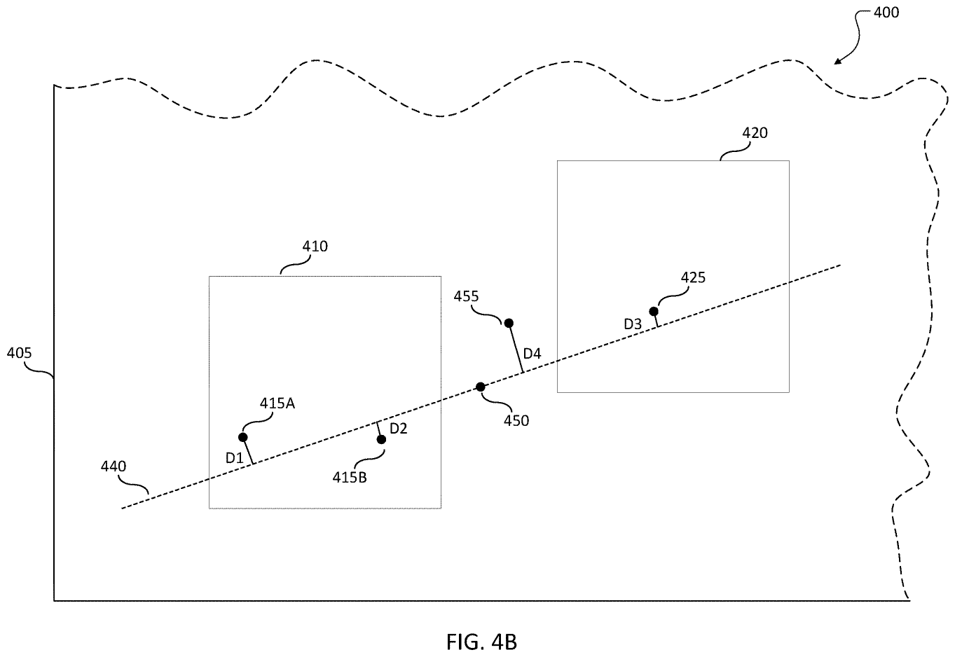

FIGS. 4A and 4B illustrate an example of using watermarks and other overt security features to encode and encrypt indicia of a security document's authenticity according to various embodiments of this disclosure. For convenience of cross-reference, elements common to both FIGS. 4A and 4B are numbered similarly.

Referring to the explanatory example of FIG. 4A, a macro, or naked-eye view security document 400 comprising a substrate 405 is shown in the figure. According to various embodiments, substrate 405 is a fibrous substrate upon which traditional watermarks can be formed as overt security features. In some embodiments, substrate 405 is a non-fibrous substrate, which, while not able to be traditionally watermarked through modulating the fiber density of a forming sheet of paper fibers, can still bear both printed and non-printed visual indicia of authenticity.

As shown in the explanatory example of FIG. 4A, security document 400 comprises a first overt indicium of authenticity 410, a second overt indicium of authenticity 420, and a third overt indicium of authenticity 430. In some embodiments, first overt indicium of authenticity 410 is a watermark formed with a wire screen, second overt indicium of authenticity 420 is a watermark formed with an electrotype, and third overt indicium of authenticity 430 is an intaglio print design. While not shown in FIG. 4A, other combinations of types of overt indicia which do not automatically self-register and for which access to original printing/embossing tools provides legitimate actors a precision advantage over counterfeiters working to reproduce copies of finished products are possible and within the contemplated scope of this disclosure. For example, in some embodiments, third overt indicium of authenticity 430 is a surface-applied security feature (for example, security feature 115 in FIG. 1).

According to various embodiments, first overt indicium of authenticity 410 (in this example, reference points 415A and 415B), second overt indicium of authenticity 420 (in this example, reference point 425), and third overt indicium of authenticity 430 (in this example, reference point 435, which corresponds to the nose of a face), comprises one or more reference points that align along alignment line 440 at a level which can be checked with the naked eye or a straightedge, providing a “Level 1” or user-detectable indicator of whether security document 400 passes a threshold criterion for authenticity.

As noted elsewhere in this disclosure, unlike legitimate producers of security documents, who start with a design specification and generate master tooling for producing the security document on purpose-specific equipment, counterfeiters necessarily operate at a disadvantage, due to the fact that they are copying and reverse-engineering from an existing product. As such, counterfeiters do not have access to either the manufacturing specifications for the original, or information as to the degree of registration accuracy to which authentic documents are manufactured. Accordingly, and as described in greater detail herein, certain embodiments according to this disclosure provide a mechanism for encoding and encrypting indicia of authenticity in the registration of overt features such that, even if counterfeiters were able to achieve greater registration precision than legitimate manufacturers, even high quality forgeries may be detected by manufacturers and others in possession of proprietary information not available to counterfeiters.

FIG. 4B presents a zoomed-in or closer view of a portion of security document 400 to illustrate how, according to some embodiments of this disclosure, the advantages in registration precision of document features available to legitimate, or original creators of security documents over counterfeiters and copiers can be leveraged to encode and encrypt “Level 2” indicators of authenticity (i.e., indicia of authenticity requiring proprietary information and/or equipment to detect).

Referring to the illustrative example of FIG. 4B, a portion of security document 400, comprising first overt indicium of authenticity 410 and second overt indicium of authenticity 420, is shown in the figure, along with alignment line 440 and the reference points contained in each of the indicia of authenticity. As shown in FIG. 4A, while reference points 415A, 415B, and 425 appear to the naked eye to sit exactly along alignment line 440, each of reference points 415A, 415B, and 425 are slightly offset relative to alignment line 440 when viewed up close, as shown in FIG. 4B. For example, reference point 415A is offset by a distance D1 along a line perpendicular to alignment line 440, reference point 415B is offset by a distance D2 along a line perpendicular to alignment line 440, and reference point 415C is offset by a distance D3 along another line perpendicular to alignment line 440.

To a counterfeiter without access to either the design specification of security document 400, or any information as to the degree of registration precision the original manufacturer can achieve, reproducing the relationship of reference points relative to alignment line 440 presents a largely insoluble problem. This is because, while original manufacturers are typically able to register security features relative to points on substrate 405 and relative to each other, it does not follow that original manufacturers are able to register features and reference points with infinite accuracy. Thus, a counterfeiter looking at reference point 415A, for example, is faced with the insoluble dilemma (because she has neither the design specification, nor any information regarding manufacturing tolerances) of whether and to what extent the direction and magnitude (i.e., above or below alignment line 440) offset D1 is a product of normal manufacturing variations or deliberate design. Provided the original manufacturer has sufficient control over manufacturing tolerances to ensure that offset D1 has the same sign across all documents and the variations in magnitude fall within a given range, offset D1 can be used to encode further, deeper indicia of security document 400 authenticity. This is because, for each reference point, a counterfeiter has to make a judgment call or guess (because they do not have either the manufacturing specification or any information regarding manufacturing tolerances) as to the what the reference point's relationship to alignment line 440 should be. As the number of reference points increases, so does the likelihood of a counterfeiter producing a copy with a reference point that is outside of the range (for example, too close or too far from alignment line 440) of permissible offset values.

Additionally, to further encode the indicia of authenticity provided by the locations of reference points in overt features relative to an alignment line (for example, alignment line 440) security document 400 may include one or more decoy reference points. As used in this disclosure, the expression “decoy reference point” refers to an overt, identifiable point in the vicinity of an alignment line, but whose offset relative to alignment line 440 does not conform to the criteria for authenticity. For example, in the illustrative example of FIG. 4B, first decoy reference point 450 sits directly on alignment line 440. In embodiments where the criteria for authenticity are that the offsets of reference points 415A, 415B, and 425 be greater than a first value and less than a second value, first decoy reference point 450 operates to mislead counterfeiters into believing that authentic security documents may have reference points with no offset from alignment line 440. Similarly, second decoy reference point 455 is positioned at an offset D4, which is greater in magnitude than offsets D1, D2, or D3. In this way, second decoy reference point 455 further obfuscates the range of offset values from alignment line 440 exhibited by authentic documents. While not shown in FIGS. 4A and 4B, further indicia of authenticity based on the position of overt references points relative to an alignment line can be encoded by making minor in the reference points' offsets relative to alignment line 440. For example, for a given run of security documents having a first range of serial numbers, first reference point 415A may be offset above alignment line 440. However, in a subsequent run of security documents having a second range of serial numbers, second reference point 415A may be offset below alignment line 440. In this way, in certain embodiments according to this disclosure, a “Level 1” security feature (i.e., the fact that each of reference points 415A, 415B, and 425 are all collinear) may be provided and, at the same time, a “Level 2” security feature only detectible by people in possession of proprietary information may also be provided. Further, embodiments according to this disclosure permit both the above-described “Level 1” and “Level 2” security features to be provided without replacement or modification of existing tooling for providing overt security features.

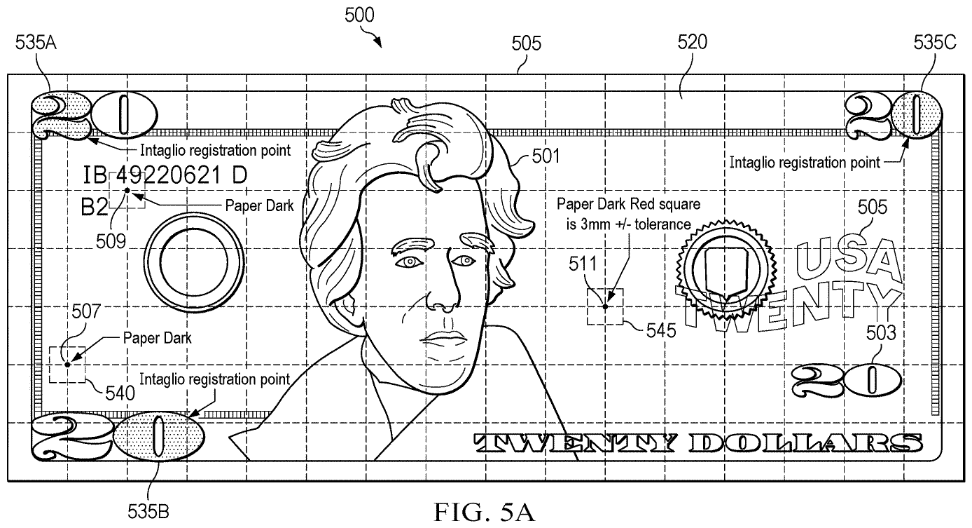

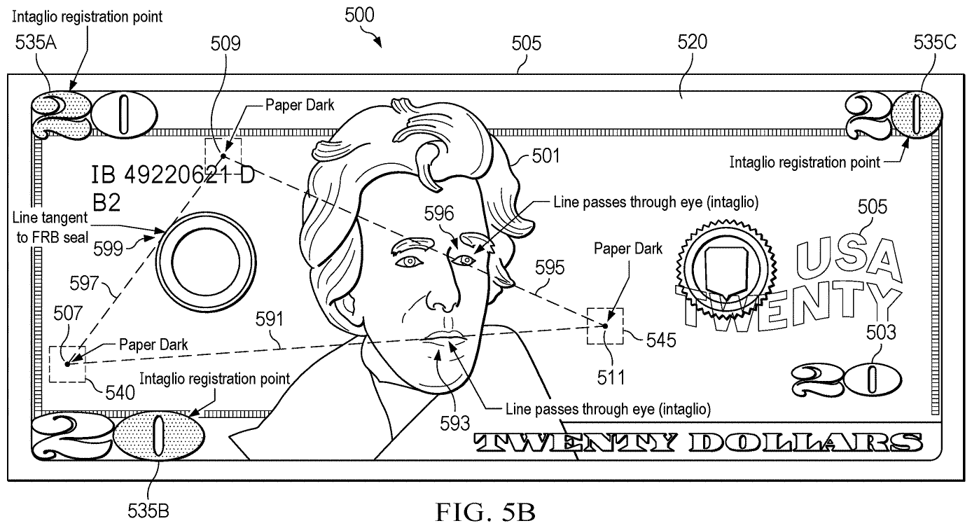

While embodiments of systems and methods for encoding indicia of a security document's authenticity through the spatial relationships between reference points in security features (for example, print and watermark features) has thus far been described with reference to examples using overt reference points, the present disclosure is not so limited. FIGS. 5A and 5B illustrate an example of encoding indicia of a security document's authenticity through spatial relationships between covert features provided on the substrate of the document. As used in this disclosure, the expression “covert features” encompasses features which, while potentially visible to the naked eye, differ from “overt features” in that their presence is not visually apparent to the viewer (for example, the arrow in FIG. 3). For convenience of cross-reference, elements common to both FIGS. 5A and 5B are numbered similarly.

Referring to the illustrative example of FIG. 5A, a security document 500 is shown. In this explanatory example, security document 500 is a prototype design of a U.S. twenty dollar bill, though skilled artisans will appreciate that embodiments according to this disclosure are not so limited. As shown in FIG. 5A, security document 500 comprises a plurality of instances and types of security features, including, without limitation, an intaglio design 501 of President Andrew Jackson's head, numbers 503 rendered in color-shifting ink, and a plurality of watermark designs, including watermark design 505, which bears the inscription “U.S. Twenty.” Given their size and prominence, security features 501, 503, and 505 comprise instances of overt features, in that, by virtue of their size and aesthetic features, they are designed to be readily noticed by the naked eye.

As shown in FIG. 5A, in this example, security document 500 also comprises three covert features, shown as elements 507, 509, and 511. According to some embodiments, first covert feature 507 comprises a dark watermark feature which is 1 mm or less in width. To the naked and/or untrained eye, first covert feature 507 appears to be a pinhead-sized manufacturing defect, wherein a spot of the substrate (for example, a sheet of fibrous or polymeric material) is darker than the surrounding material. In this example, first covert feature 507 is, in contrast to the arrow in FIG. 3, not part of or immediately associable with another security feature of security document 500. Additionally, security document 500 comprises a second covert feature 509 and third covert feature 511. In this explanatory example, each of covert features 507, 509, and 511 are dark watermark features, though the present disclosure is not so limited. In some embodiments, one or more covert features may be provided as a light watermark feature or a print feature.

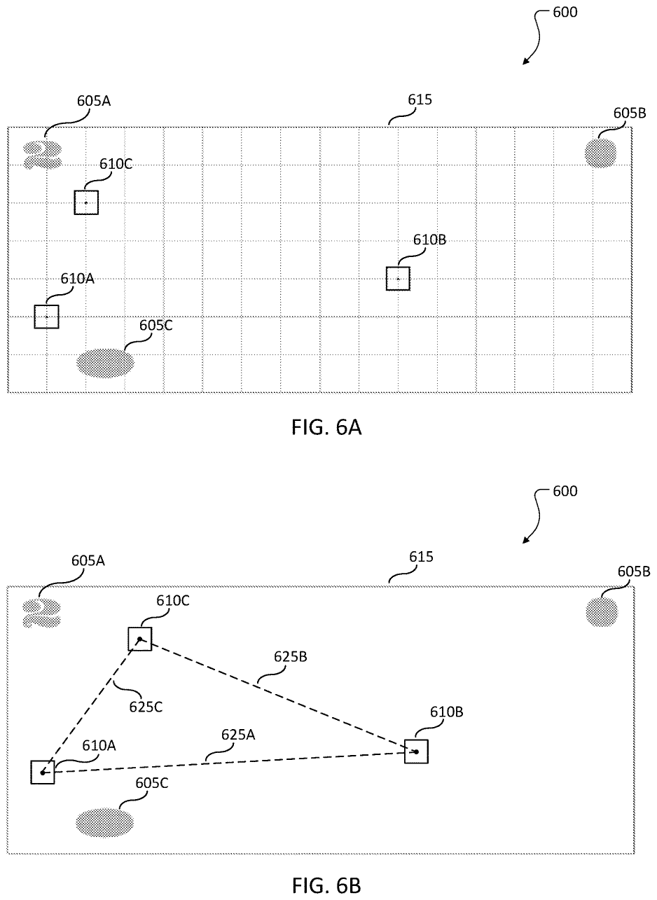

Encoding the location of the covert features of security document 500 as indicia of the authenticity according to certain embodiments of this disclosure may be achieved in a plurality of ways. For example, as shown in FIG. 5A, the authenticity of security document through covert features 507 can be established by determining whether the features register to predetermined locations within a coordinate system. In this example, locations within security document 500 may be described with reference to a coordinate grid comprising vertical lines (for example, vertical line 520) and horizontal lines (for example, horizontal line 530). In certain embodiments, the coordinate grid may be anchored (i.e., by defining a consistent origin for the coordinate system) by matching the locations of registration points (for example, intaglio print features 535A-C) to anchor points of known regions of the coordinate system. As described in greater detail with reference to FIGS. 6A and 6B of this disclosure, gridlines and/or anchor points of the coordinate system may be provided on an authenticating overlay. As used in this disclosure, the expression “authenticating overlay” encompasses clear films which can be placed atop security document 500 to define and identify regions within the coordinate system.

Still referring to the illustrative example of FIG. 5A, in certain embodiments in which indicia of security document 500's authenticity are encoded through the position of covert features 507, 509, and 511 relative to coordinates of a grid system, the criteria for authenticity may include whether each of the covert features occupies a location in the grid system corresponding to a specific registration region. For example, in an authentic version of security document 500, covert feature 507 occupies first registration region 540. Depending on the level of process control and registration precision available to the original manufacturer, the size of and shape of first registration region 540 may be modulated to further encode the criteria for authenticity. For example, first registration region 540 for covert feature 507 may have dimensions of 3 mm×3 mm, while second registration region 545 may be smaller, having dimensions of 2.5 mm×2.5 mm. Additionally, where a legitimate manufacturer's process control and manufacturing tolerances permit, one or more of the registration regions may, in addition to a shape having an external perimeter, include one or more internal perimeters such that the covert feature in an authentic document is positioned between the internal and external perimeter. Examples of shapes with internal perimeters include rings and figure eights. By defining one or more registration regions to have an internal perimeter, legitimate manufacturers can make it significantly harder for counterfeiters to deduce or correctly guess the spatial criteria for authenticity. Additionally, as with the overt features discussed with reference to FIGS. 4A and 4B of this disclosure, in certain embodiments according to this disclosure, the registration criterion for authenticity can be further concealed through the use of decoy covert features whose registration deliberately falls outside of the criteria for authentic documents.

FIG. 5B illustrates a further example of encoding indicia of security documents through covert features according to various embodiments of this disclosure. Instead of, or in addition to, using the alignment of covert features to locations in a coordinate grid, as described with reference to FIG. 5A, covert features can be used as part of a vector or alignment-line method of confirming that the relative registration of features of a security document conforms to authenticity criteria. Referring to the illustrative example of FIG. 5B, the alignment of vectors, or alignment lines, connecting each of covert features 507, 509, and 511 to each other with overt features of security document 500 operates as a way of encoding further indicia of authenticity through the registration of features within the document. As shown in FIG. 5B, first alignment line 591 connects covert features 507 and 511 and aligns at point 593 with the mouth of President Jackson's face. Similarly, second alignment line 595 connects covert features 511 and 509 and intersects President Jackson's eye at point 596. Finally, third alignment line 597 connects covert features 507 and 509 such that it appears to be perfectly tangential with the perimeter of the Federal Reserve seal at point 599. In this way, the alignment of vectors, or alignment lines, linking the covert features with overt features provides an encoded indicia of security document 500's authenticity.

While not shown in the explanatory example of FIG. 5B, in certain embodiments, decoy features (either overt or covert) may be provided on security document 500 to mislead illegitimate manufacturers or disguise the location of the actual covert features, and/or the registration criteria associated with the alignment between alignment lines and overt features.

Although the present disclosure has been described with various embodiments, various changes and modifications may be suggested to one skilled in the art. It is intended that the present disclosure encompass such changes and modifications as falling within the scope of the claims.

While increasing the complexity of the registration criteria of authenticity between covert and overt features makes successful counterfeiting more difficult, it can also pose challenges for manufacturers and other approved personnel evaluating the authenticity of sample security documents. FIGS. 6A and 6B illustrate two examples of authenticating overlays according to various embodiments of this disclosure. For convenience of cross-reference, elements common to both FIGS. 6A and 6B are numbered similarly.

Referring to the illustrative example of FIG. 6A, an authenticating overlay 600 for authenticating the twenty dollar bills described with reference to FIGS. 5A and 5B is shown in the figure. According to various embodiments, authenticating overlay 600 comprises a section of mylar, polyester film, glass, or some other substantially transparent material which is stable (i.e., not experiencing dimensional change on the same order as the registration tolerances of features of a security document in response to changes in heat or humidity) and can be etched, printed upon, or otherwise visibly marked. In this example, authenticating overlay 600 comprises a section of laser-etched glass.

As shown in FIG. 6A, authenticating overlay 600 is etched with the locations of anchor features 605A-C (referring to features that occupy, to the extent the manufacturer's registration abilities allow, the same location on a security document). In this case, anchor features 605A-C correspond to the intaglio printed features of denomination numbers of the security document (for example, intaglio printed features 535A-C in FIG. 5A). Anchor features 605A-C may be aligned to the matching features of the security document under examination to conform the coordinate system of the authentication features of the security document to those of authentication overlay 600. According to various embodiments, authentication overlay 600 further comprises one or more markings defining registration regions. As used in this disclosure, the expression “registration region” encompasses a range of location values that, if a feature (covert or overt) falls within, are indicative of the security document's authenticity. Authentication overlay 600 comprises etchings demarcating registrations regions 610A-C, which define acceptable (i.e., within a range of positions associated with authentic documents) for covert features 507, 509, and 511 of security document 500. According to some embodiments, authentication overlay 600 may further comprise grid lines (for example, grid line 610) to facilitate assessment of the size and registration of other features of a security document.

Referring to FIG. 6B, another example embodiment of authentication overlay 600 according to some embodiments of this disclosure is shown in the figure. In this explanatory example, the grid lines are replaced with lines 625A-C, connecting each of the covert features provided in registration regions 610A-C. In this way, the presence or absence of authentication information encoded through the alignment of lines connecting covert features with overt or other features on the security document can be readily determined. For example, using authentication overlay 600, a bank official or other authorized user can determine whether alignment line 625A passes through Andrew Jackson's mouth in the manner associated with an authentic security document.

Examples of security documents according to some embodiments of this disclosure include a security document comprising a substrate; a first indicia occupying a first predetermined region of the substrate, the first indicia having a first pattern comprising first and second reference points; and a second indicia occupying a second predetermined region of the substrate, the second indicia having a second pattern comprising a third reference point, wherein the first reference point, second reference point and third reference point fit a first line, wherein a distance between the first line and the first reference point comprises a first perpendicular offset, wherein a distance between the first line and the second reference point comprises a second perpendicular offset, wherein a distance between the first line and the third reference point comprises a third perpendicular offset, and wherein each of the first, second and third perpendicular offsets are equal to, or less than a first threshold value.

Examples of security documents according to some embodiments of this disclosure include security documents wherein the first threshold value is between 2 and 3 mm.

Examples of security documents according to some embodiments of this disclosure include security documents wherein the first threshold value is between 1.5 and 2 mm.

Examples of security documents according to some embodiments of this disclosure include security documents wherein the first threshold value is between 0.75 and 1.5 mm.

Examples of security documents according to some embodiments of this disclosure include security documents wherein the first threshold value is between 0.4 and 0.75 mm.

Examples of security documents according to some embodiments of this disclosure include security documents wherein the first indicia comprises a wire mesh watermark and the second watermark comprises an electrotype watermark.

Examples of security documents according to some embodiments of this disclosure include security documents comprising a fourth reference point, wherein a distance between the first line and the fourth reference point comprises a fourth offset, wherein the fourth offset is equal to, or less than the first threshold value.

Examples of security documents according to some embodiments of this disclosure include security documents wherein the fourth reference point comprises one or more of: a printed feature on the substrate, a feature of a micro-optic security device, or a machine-readable feature.

Examples of security documents according to some embodiments of this disclosure include security documents comprising one or more decoy reference points.

Examples of security documents according to some embodiments of this disclosure include security documents wherein each of the first, second and third perpendicular offsets are equal to, or greater than a second threshold value.

Examples of methods of making security documents according to some embodiments of this disclosure include methods comprising forming, in or on a substrate, a first indicia occupying a first predetermined region of the substrate, the first indicia having a first pattern comprising first and second reference points; and forming, in or on the substrate, a second indicia occupying a second predetermined region of the substrate, the second indicia having a second pattern comprising a third reference point, wherein the first reference point, second reference point and third reference point fit a first line, wherein a distance between the first line and the first reference point comprises a first perpendicular offset, wherein a distance between the first line and

the second reference point comprises a second perpendicular offset, wherein a distance between the first line and the third reference point comprises a third perpendicular offset, wherein each of the first, second and third perpendicular offsets are equal to, or less than a first threshold value.

Examples of methods of making security documents according to some embodiments of this disclosure include methods wherein the first threshold value is between 2 and 3 mm.

Examples of methods of making security documents according to some embodiments of this disclosure include methods wherein the first threshold value is between 1.5 and 2 mm.

Examples of methods of making security documents according to some embodiments of this disclosure include methods wherein the first threshold value is between 0.75 and 1.5 mm.

Examples of methods of making security documents according to some embodiments of this disclosure include methods wherein the first threshold value is between 0.4 and 0.75 mm.

Examples of methods of making security documents according to some embodiments of this disclosure include methods wherein the first indicia comprises a wire mesh watermark and the second watermark comprises an electrotype watermark.

Examples of methods of making security documents according to some embodiments of this disclosure include methods comprising a fourth reference point, wherein a distance between the first line and the fourth reference point comprises a fourth offset, wherein the fourth offset is equal to, or less than the first threshold value.

Examples of methods of making security documents according to some embodiments of this disclosure include methods wherein the fourth reference point comprises one or more of: a printed feature on the substrate, a feature of a micro-optic security device, or a machine-readable feature.

Examples of methods of making security documents according to some embodiments of this disclosure include methods further comprising one or more decoy reference points.

Examples of security documents according to some embodiments of this disclosure include security documents comprising a substrate having a predetermined width and a predetermined length; a first covert feature formed in the substrate; and a second covert feature formed in the substrate; wherein the first covert feature is disposed at a first location on the substrate, the first location corresponding to a first registration region of an authenticating overlay, and wherein the second covert feature is disposed at a first location on the substrate, the first location corresponding to a second registration region of the authenticating overlay.

Examples of security documents according to some embodiments of this disclosure include security documents comprising a first overt feature on the substrate, wherein a line passing through the first covert feature and the second covert feature aligns with the first overt feature.

Examples of security documents according to some embodiments of this disclosure include security documents wherein a distance between the first overt feature and the line passing through the first covert feature and the second covert feature defines a first perpendicular offset, and wherein a magnitude of the first perpendicular offset is less than a threshold value.

Examples of security documents according to some embodiments of this disclosure include security documents wherein the threshold value is between 1.5 and 2 mm.

Examples of security documents according to some embodiments of this disclosure include security documents wherein the threshold value is between 0.75 and 1.5 mm.

Examples of security documents according to some embodiments of this disclosure include security documents wherein the threshold value is between 0.4 and 0.75 mm.

Examples of security documents according to some embodiments of this disclosure include security documents wherein the first covert feature is a watermarked dark feature.

Examples of security documents according to some embodiments of this disclosure include security documents wherein the first covert feature is a watermarked light feature.

Examples of security documents according to some embodiments of this disclosure include security documents comprising one or more decoy covert features.

Examples of security documents according to some embodiments of this disclosure include security documents wherein the first registration region comprises an area between an exterior perimeter and one or more internal perimeters.

Examples of methods of making security documents according to some embodiments of this disclosure include methods comprising on a substrate having a predetermined width and a predetermined length, forming a first covert feature in or on the substrate; and forming a second covert feature in or on the substrate; wherein the first covert feature is disposed at a first location on the substrate, the first location corresponding to a first registration region of an authenticating overlay, and wherein the second covert feature is disposed at a first location on the substrate, the first location corresponding to a second registration region of the authenticating overlay.

Examples of methods of making security documents according to some embodiments of this disclosure include methods comprising forming a first overt feature in or on the substrate, wherein a line passing through the first covert feature and the second covert feature aligns with the first overt feature.

Examples of methods of making security documents according to some embodiments of this disclosure include methods wherein a distance between the first overt feature and the line passing through the first covert feature and the second covert feature defines a first perpendicular offset, and wherein a magnitude of the first perpendicular offset is less than a threshold value.

Examples of methods of making security documents according to some embodiments of this disclosure include methods wherein the threshold value is between 1.5 and 2 mm.

Examples of methods of making security documents according to some embodiments of this disclosure include methods wherein the threshold value is between 0.75 and 1.5 mm.

Examples of methods of making security documents according to some embodiments of this disclosure include methods wherein the threshold value is between 0.4 and 0.75 mm.

Examples of methods of making security documents according to some embodiments of this disclosure include methods wherein the first covert feature is a watermarked dark feature.

Examples of methods of making security documents according to some embodiments of this disclosure include methods wherein the first covert feature is a watermarked light feature.

Examples of methods of making security documents according to some embodiments of this disclosure include methods comprising forming one or more decoy covert features in or on the substrate.

Examples of methods of making security documents according to some embodiments of this disclosure include methods wherein the first registration region comprises an area between an exterior perimeter and one or more internal perimeters.

Examples of methods of making security documents according to some embodiments of this disclosure include methods wherein each of the first, second and third perpendicular offsets are equal to, or greater than a second threshold value.

1. A security document comprising:
a substrate;
a first indicia occupying a first predetermined region of the substrate, the first indicia having a first pattern comprising a first reference point and a second reference point; and
a second indicia occupying a second predetermined region of the substrate, the second indicia having a second pattern comprising a third reference point,
wherein the first reference point, second reference point, and third reference point fit a first line,
wherein a distance between the first line and the first reference point comprises a first perpendicular offset,
wherein a distance between the first line and the second reference point comprises a second perpendicular offset,
wherein a distance between the first line and the third reference point comprises a third perpendicular offset, and
wherein each of the first, second, and third perpendicular offsets are equal to or less than a first threshold value.

2. The security document of claim 1, wherein the first threshold value is between 2 and 3mm.

3. The security document of claim 1, wherein the first threshold value is between 1.5 and 2mm.

4. The security document of claim 1, wherein the first threshold value is between 0.75 and 1.5 mm.

5. The security document of claim 1, wherein the first threshold value is between 0.4 and 0.75mm.

6. The security document of claim 1, wherein the first indicia comprises a wire mesh watermark and the second indicia comprises an electrotype watermark.

7. The security document of claim 1, further comprising a fourth reference point, wherein a distance between the first line and the fourth reference point comprises a fourth perpendicular offset, wherein the fourth perpendicular offset is equal to or less than the first threshold value.

8. The security document of claim 7, wherein the fourth reference point comprises one or more of: a printed feature on the substrate, a feature of a micro-optic security device, or a machine-readable feature.

9. The security document of claim 1, further comprising one or more decoy reference points.

10. The security document of claim 1, wherein each of the first, second, and third perpendicular offsets are equal to or greater than a second threshold value.

11. A method of making a security document, the method comprising:
forming, in or on a substrate, a first indicia occupying a first predetermined region of the substrate, the first indicia having a first pattern comprising a first reference point and a second reference point; and
forming, in or on the substrate, a second indicia occupying a second predetermined region of the substrate, the second indicia having a second pattern comprising a third reference point,
wherein the first reference point, second reference point, and third reference point fit a first line,
wherein a distance between the first line and the first reference point comprises a first perpendicular offset,
wherein a distance between the first line and the second reference point comprises a second perpendicular offset,
wherein a distance between the first line and the third reference point comprises a third perpendicular offset, and
wherein each of the first, second, and third perpendicular offsets are equal to or less than a first threshold value.

12. The method of claim 11, wherein the first threshold value is between 2 and 3 mm.

13. The method of claim 11, wherein the first threshold value is between 1.5 and 2 mm.

14. The method of claim 11, wherein the first threshold value is between 0.75 and 1.5 mm.

15. The method of claim 11, wherein the first threshold value is between 0.4 and 0.75 mm.

16. The method of claim 11, wherein the first indicia comprises a wire mesh watermark and the second indicia comprises an electrotype watermark.

17. The method of claim 11, further comprising a fourth reference point, wherein a distance between the first line and the fourth reference point comprises a fourth perpendicular offset, wherein the fourth perpendicular offset is equal to or less than the first threshold value.

18. The method of claim 17, wherein the fourth reference point comprises one or more of: a printed feature on the substrate, a feature of a micro-optic security device, or a machine-readable feature.

19. The method of claim 11, further comprising one or more decoy reference points.

20. The method of claim 11, wherein each of the first, second, and third perpendicular offsets are equal to or greater than a second threshold value.
